(19) United States
(12) Patent Application Publication
(10) Pub. No.: US 2014/0357302 A1
(43) Pub. Date: Dec. 4, 2014

(54) RECEIVER SIGNAL MAPPING WEBSITE PLATFORM AND DATABASE

(71) Applicant: John Russell Wilbur, San Jose, CA (US)

(72) Inventor: John Russell Wilbur, San Jose, CA (US)

(21) Appl. No.: 14/289,565

(22) Filed: May 28, 2014

Related U.S. Application Data
(60) Provisional application No. 61/828,538, filed on May 29, 2013.

(51) Int. Cl. H04W 4/02; G06F 17/30; H04W 64/00

(52) U.S. Cl. CPC H04W 4/025; H04W 64/006; G06F 17/30241
USPC 455/456.3

(57) ABSTRACT

A software application installed on a mobile device periodically measures a parameter and records it along with the position associated with the measurement. These parameter and position data are transmitted to a repository database, from which all or part of the set of data can be retrieved based on filters applied by users or automated software. In one embodiment, the parameter may be cellular signal strength, allowing users in areas with no useable cellular signal to display signal strength as a map and to find a location where a phone call can be placed. Parameter and location data may be downloaded from the repository database onto a device's internal memory such that it can be accessed, filtered, and displayed as a map without the need to connect to the internet.

### CROSS-REFERENCE TO RELATED APPLICATIONS

The present application claims priority to a Provisional Patent Application 61/828,538, filed on May 29, 2013. All disclosure of the prior application is incorporated herein at least by reference.

### BACKGROUND OF THE INVENTION

1. Field of the Invention

The present invention generally relates to the technical field of wireless communication devices and, in particular, to techniques for measuring, recording, storing, retrieving, and displaying signal strengths and other parameters as a function of location.

2. Description of Related Art

It is well known in the art that cellular wireless systems rely on base stations that cover a limited geographic area, and that a cellular telephone needs to be within the reach of a base station to be able to place, receive, or conduct a call. Coverage in any cellular system is not universal, and cell phones are well-known to have an ability to display signal strength.

In some circumstances signal strength may be a life-or-death matter. There are many instances where a person or persons have gotten lost in an area with poor or no cellular coverage and have died as a result of not being able to call for help.

There exist databases of cellular signal strength as a function of location, but these data are unavailable when a user needs them the most, that is, when the user is already in a location with no useable cellular signal.

When a cellular phone user has poor or no cellular coverage, there is no way for said user to know where a useable cellular signal might be found. For example, thousands of people die every year while lost in the wilderness, but if they were able to place phone calls for help they could be rescued. Many of those people are within walking distance of a useable cellular signal but have no way of knowing whether it exists or where to find it. All existing web-based signal strength databases provide no information when users need it most, i.e., when they have no cellular coverage.

A solution to this technical problem that would provide signal strength and location information to users in a no-coverage location, allowing them to find a useable cellular signal would thus be of great value. Several advantages of one or more aspects are to provide a map of cellular signal strength data as a function of location that is available to a mobile device user even when said device is unable to access the internet. These and other advantages of one or more aspects will become apparent from a consideration of the ensuing description and accompanying drawings.

### BRIEF SUMMARY OF THE INVENTION

In accordance with one embodiment, a software application installed on a mobile device records a received cellular signal strength and an associated latitude and longitude at predefined intervals of time or distance. The signal strength and corresponding location coordinates may be transmitted to one or multiple repository databases. Before a user enters an area with poor signal strength, the signal strength and corresponding location coordinates for that area, previously collected by one or more devices or users and stored in the repository databases, may be transmitted from said repository databases to the user's mobile device and stored in its internal memory. Said signal strength and corresponding location coordinates can provide the user of said device with a map of signal strength as a function of location even in an area with no cellular coverage and thus no ability to access the data from the repository databases in real time.

The repository databases and associated software may transmit the signal strength and corresponding location coordinates through an automated process without prompting by the user, with the locations to be covered by said signal strength data chosen based on the user's direction of travel or through an analysis of the user's upcoming travel plans attained through electronic records on the user's phone, computer system, electronic mail service, or another internet-connected account. In addition to cellular signal strength, other parameters may be recorded in repository databases and retrieved for the user using the same method. In addition to loading onto a mobile device's internal memory, parameter data and corresponding location coordinates may be displayed as a map layer through a user interface accessible through the internet and printed on paper or displayed on another device such as a tablet or dedicated GPS navigator, allowing even users who do not possess smartphones to access and benefit from the data in the repository database.

### BRIEF DESCRIPTION OF THE SEVERAL VIEWS OF THE DRAWINGS

FIG. 1 is a view of signal strength and corresponding location data stored in a repository database, retrieved based on user-inputted filters, and displayed as a map through a user interface accessible through the internet.

FIG. 2 is a view of a software application running on a cellular phone displaying signal strength and corresponding location data retrieved from a repository database as a map.

### DETAILED DESCRIPTION OF THE INVENTION

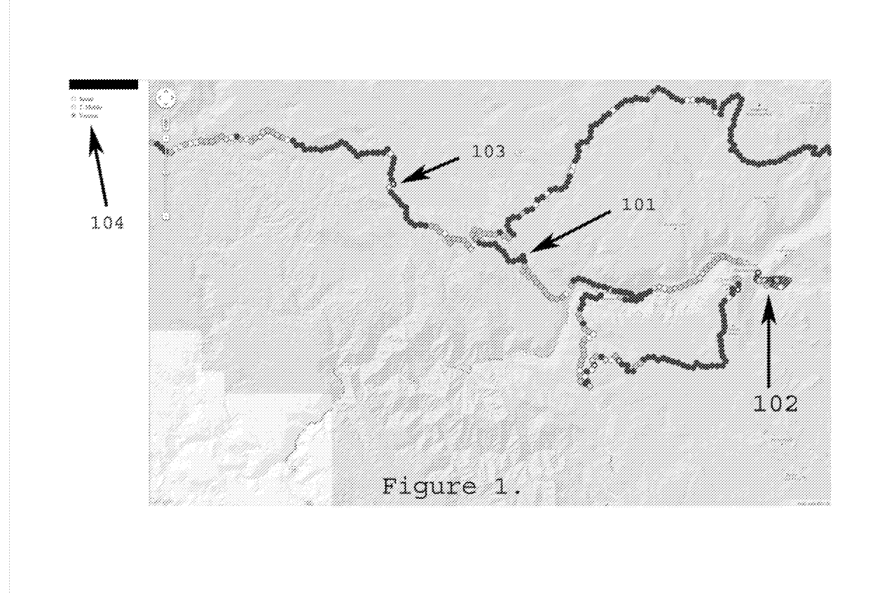

FIG. 1 is a view of signal strength and corresponding location data stored in a repository database, retrieved based on user-inputted filters, and displayed as a map through a user interface accessible through the internet. In this embodiment signal strength at a given location is indicated by the color and shape of circular icons displayed at said location on a map. In this embodiment, red circular icons 101 indicate a signal strength that was very low or undetectable, green circular icons represent a strong, useable cellular strength, and yellow circular icons represent an intermediate signal strength between the signal strength represented by a red icon and the signal strength represented by a green icon.

In this embodiment, the spacing between icons to be displayed is adjustable by the user, with a ¼ mile spacing selected at the location of the red circular icons 101 and a 150 foot spacing selected at the location of the more densely populated icons 102.

In this embodiment, icons containing multiple colors such as the red and yellow icon and green and yellow icon 103 indicate signal strength between red and yellow or green and yellow thresholds, respectively. In this embodiment the signal strength thresholds corresponding to each icon design are selectable by the user.

In this embodiment, the user interface allows users to select a cellular service provider through the menu 104. When a user selects a service provider, signal strength and corresponding location data collected by devices connected to the selected provider's network are retrieved from the repository database and displayed on the map.

The subset of data retrieved from the repository database can be adjusted by the user, software running on the user's mobile device or computer, or the software running on the repository database server based on parameters including cellular service provider, location, time, device model, elevation, average strength of a signal in the area, and other parameters.

Users may employ accessories such as mobile signal enhancers to increase the signal strength of the mobile signal accessed by their mobile devices. When signal strength and corresponding location data are uploaded to a repository database or repository databases, the presence and identity of said accessories is simultaneously uploaded and associated with said data. Users may filter the displayed or downloaded signal strength and corresponding location data based on the presence and type of accessories used to collect said data.

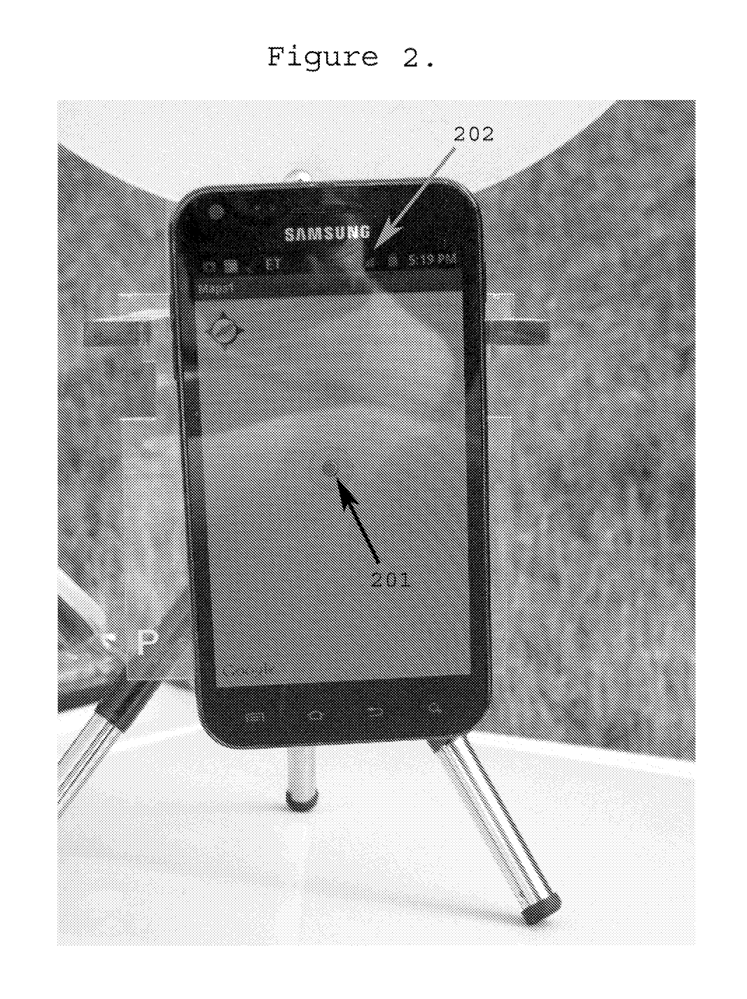

FIG. 2 is a view of a software application running on a cellular phone displaying signal strength and corresponding location data retrieved from a repository database as a map. The map is similar to the map shown in FIG. 1, but in this embodiment the data retrieved from the repository database was stored on the mobile device's internal memory rather than being displayed on a computer monitor or printed on paper. In this embodiment, a blue circular icon indicates the device's current location and colored circular icons 201 indicate the signal strength at corresponding locations downloaded from the repository database.

The signal strength indicator 202 in FIG. 2 shows a strong useable signal as indicated by the icon composed of four vertical bars. The strong cellular signal corresponds with the green circular icon displayed at the user's location on the mobile device.

The map of signal strength as a function of location displayed in FIG. 2 is a subset of the signal strength and corresponding location data stored in the mobile device's internal memory. In this embodiment, data stored in a mobile device's internal memory can be filtered based on parameters including cellular service provider, location, time, device model, elevation, average strength of a signal in the area, type of associated signal-enhancing accessories, and other parameters. Users can alter filter parameters and update the displayed map in real time on their mobile devices.

In one embodiment, before a user enters an area with poor signal strength, the signal strength and corresponding location coordinates for that area, previously collected by one or more devices or users and stored in the repository databases, may be transmitted from said repository databases to the user's mobile device and stored in its internal memory. Said signal strength and corresponding location coordinates can provide the user of said device with a map of signal strength as a function of location even in an area with no cellular coverage and thus no ability to access the data from the repository databases in real time.

The repository databases and associated software may transmit the signal strength and corresponding location coordinates through an automated process without prompting by the user, with the locations to be covered by said signal strength data chosen based on the user's direction of travel or through an analysis of the user's upcoming travel plans attained through electronic records on the user's phone, computer system, electronic mail service, or another internet-connected account. In one embodiment, the software may measure the direction of travel of the device, detect that the device's path will take it into an area with no useable cellular signal, and then download mobile signal strength and location data around that area while the device still has a functional data connection.

In one embodiment, the data may be displayed as a user selectable map layer on any mapping website, such as Google Maps, Google Earth, Yahoo Maps, Bing Maps, or others. The maps on these sites or on the described website map interface may be printed, enabling a user with or without a smartphone to see, for example, where a mobile phone call could be made on a trail or road that they plan to visit. Standard GPS data file types that the data can be adapted to include .gpx, .csv, .xml, .txt, .kml, .kmz and others as needed.

In one embodiment, data described in this specification can be transferred to a dedicated GPS receiver and displayed to users through its interface.

Additional types of spatially dependent data stored in the database and visible through the website interface may include location-specific news stories describing people who have benefitted from using the map data to successfully direct them to a usable signal location in order to complete a call, reviews of devices relevant to mobile device signal strength, advertisements for hardware or software related to mobile devices, and any other information deemed appropriate by the database owners. These additional types of data may be in the form of text, photos, video, audio, or any other format. Advertisements based on the user's location and other data filtering parameters may also be included on the above described database website.

Although the present disclosure refers expressly to the “GPS” or “Global Positioning System”, it should be understood that this term and its abbreviation “GPS” are being used expansively to include any satellite-based navigation-signal broadcast system, and would therefore include other systems used around the world including the Beidou (COMPASS) system being developed by China, the multi-national Galileo system being developed by the European Union, in collaboration with China, Israel, India, Morocco, Saudi Arabia and South Korea, Russia's GLONASS system, India's proposed Regional Navigational Satellite System (IRNSS), and Japan's proposed QZSS regional system.

It will be apparent to a skilled artisan that the embodiments described above are exemplary of inventions that may have greater scope than any of the singular descriptions. There may be many alterations made in these examples without departing from the spirit and scope of the invention. For example, the embodiments described above describe cellular signal strength as the primary layer, but any parameter measureable by the mobile device could be measured, recorded, and displayed using this method. For example, a device could measure, record, and display temperature, chemical concentration, radioactivity, or landmine locations using this method. These and many other features may change in different embodiments.

1. A method for providing users with cellular signal strength as a function of location, comprising:
a) measuring the strength of a cellular signal and an associated location,
b) transmitting said cellular signal strength and said location values to a repository database,
c) means for retrieving all or a subset of said cellular signal strength and said location values from said repository database, and
d) means for displaying said signal strength and location values,
whereby said display of signal strength and location data form a map that will show whether the mobile device can connect to a cellular network at each indicated location, and said map will be accessible without the need to access a mobile data connection.
